(19) United States
(12) Patent Application Publication
(10) Pub. No.: US 2016/0084522 A1
(43) Pub. Date: Mar. 24, 2016

(54) METHOD FOR CONTROLLING A HOT BEVERAGE PREPARATION DEVICE

(71) Applicant: BSH HAUSGERÄTE GMBH, München (DE)

(72) Inventors: STEFAN BAUMGART, TROSTBERG (DE); JOSEF DABURGER, SIEGSDORF-HAMMER (DE); CHRISTIAN SCHNELLINGER, WONNEBERG (DE); FLORIAN SCHOLZ, TRAUNSTEIN (DE)

(21) Appl. No.: 14/785,405

(22) PCT Filed: Apr. 10, 2014
(86) PCT No.: PCT/EP2014/057282

§ 371 Date: Oct. 19, 2015

(30) Foreign Application Priority Data
Apr. 19, 2013 (DE) 10 2013 207 182.5

(51) Int. Cl. F24H 1/10; H05B 3/78; A47J 31/56

(52) U.S. Cl. CPC F24H 1/101; A47J 31/56; H05B 3/78

(57) ABSTRACT

A method for controlling a hot beverage preparation device, in particular a hot beverage machine for household use. The device has a heating system, at least one temperature sensor downstream of the heating system, a pump for conveying water within the preparation device, a control unit for controlling the heating system and the pump. The novel method includes the steps of subjecting the heating system to electric power, detecting a change in temperature downstream of the heating system after a defined period of time has passed, evaluating the detected change in temperature by comparing it to a target value, and outputting an error message or continuing/initiating a brewing process.

The invention relates to a method for controlling a hot beverage preparation appliance, in particular one for household purposes, having a heater, having a temperature sensor downstream of the heater, having a pump for conveying water within the preparation appliance and having a control device for controlling the heater and the pump. The heater used for the preparation appliance can be for example a thermoblock, a flow-through water heater or a combination of the two. In expensive preparation appliances the pump can be replaced by a water connector to the household water network and is therefore not required. The control device controls the heater and the pump or in some instances from time to time just one of the two. To this end it can process in particular signals from the temperature sensor as well as user input.

Preparation appliances for household purposes should in particular be user-friendly as well as being compact in respect of dimensions and as economical as possible. In order to reduce costs the hot beverage preparation appliance can be configured without a flowmeter. Its function can be replaced by a control device performing a method according to application no. DE 10 2011 079 542 B1 or DE 10 2013 201 180 A1 by the applicant. If there is no flowmeter it is no longer possible to perform conventional system tests relating to the function of individual system components, in particular the heater and pump.

The object of the invention is therefore to specify a method for controlling a hot beverage preparation appliance, with which an informative system test can be performed even without a flowmeter.

This object is achieved with a method for controlling a hot beverage preparation appliance, subdivided into the following steps:
a) applying electric power to the heater,
b) detecting a temperature change downstream of the heater after a defined time period has passed,
c) evaluating the detected temperature change by comparing it with a predetermined target value, and
d) outputting an error message or continuing the brewing operation.

The method is performed in conjunction with and generally before a brewing operation. To this end the heater is first activated. A certain time period, specifically a defined time interval, is then allowed to pass. This serves to cancel out dead times of the system, within which it is not possible to count on a response, in particular any temperature change at the temperature sensor. The duration of the time period is also based on the inertia of the system, for example that of the temperature sensor and the heater. It lasts until the heater responds to the electric power supplied with a temperature change. The inertia of the heater can increase, for example due to calcification.

After the defined time interval has passed, a temperature change is detected in step b). A temperature change can be expected when the heater is full of water, it and temperature detection both function and the heater heats the water in it. A temperature change also includes such a change with the value 0. It results from the difference between two measurement values. The measurement values can be detected by the temperature sensor downstream of the heater before the first method step a) and afterwards in method step b). Alternatively a current measurement value can be compared with a stored target value of 60° C. for example.

The amount of the temperature change is compared in step c) with a stored target value, which corresponds to a minimum power of the heater. If it is not present, an error message is output in step d). The outputting of the message does not have to be identifiable to the user but can also simply be stored as information in the control device. It can result in the control device initiating an error elimination method. As the absence of a temperature change in step c) can be due either to a defect in the heater or to the fact that the heater is not full of water, or even both situations occurring, an error elimination method can in some instances at least limit the error.

Because there is no flowmeter, the invention does not couple an error indication directly to the detection of a flow. Rather it follows the principle of applying energy to the heater and analyzing any resulting temperature change. It is therefore possible to perform function tests despite there being no flowmeter, thereby ensuring the function and operational reliability of the hot beverage preparation appliance.

In step a) electric power is applied to the heater with the aim of heating water. The duration of the power application and/or its level can be varied depending on the time available for this. According to one advantageous embodiment of the method the electric power in step a) can correspond to a predetermined and standardized amount of energy, which therefore corresponds to a previously determined target value according to step c) for an expected temperature change. The predetermined amount of energy or energy block is therefore determined by a set electric power, which is applied during a similarly set time period. It can be calculated from the mass of the heater to be heated and the mass of water to be heated as well as a desired increase in the temperature of the water in the heater. If heater values are otherwise unchanged, a defined temperature increase corresponds to the energy block. It can vary to a small extent due to manufacturing tolerances of the heater and to a greater extent due to the degree of calcification of the heater. These possible and the maximum permissible degrees of fluctuation can however also be defined beforehand and can be taken into account during the evaluation of the detected temperature change. Setting an energy block and an associated target value for the temperature change simplifies the evaluation of the detected temperature change in step c) and therefore accelerates the method.

In the verification method described to date it is therefore possible—subject to intact temperature detection—for two independent errors to have occurred in each instance, namely either for the heater not to function or the heater not to be filled with water (dry start). A first option for error elimination can therefore consist of filling the possibly empty but functioning heater with water. According to a further advantageous embodiment of the invention therefore the abovementioned method can be run through again up to the error message in step d), with the pump also being activated in step a) to fill or vent the heater.

Activation of the pump is linked directly in respect of time to step a) in that it takes place in principle during activation of the heater. According to a simple embodiment the heater and pump are activated at the same time. Alternatively it may be expedient to activate the pump slightly beforehand, for example up to 10 seconds beforehand, so that the heater is also reliably filled by its activation time point. A certain lead time of the 10 seconds mentioned above may be required because of the line length between pump and heater or pump inertia. According to a further alternative however the pump can also be switched on later than the heater, namely if the heater displays a certain inertia.

After activation of the pump the further steps of the system test described above can follow, specifically step b) according to which a temperature change is detected after a defined time period has passed. The temperature change is then evaluated in step c) and in step d) a corresponding outputting of an error message is brought about or the brewing operation is continued.

As the pump is also activated in step a), water flows through the heater as the defined time period passes in step b). Therefore when the pump is activated in step a), an energy block should optionally be set, which comprises a higher electric power and/or a longer time interval, in order to take into account the flow of water in the heater. Alternatively if the same energy block is always used, a smaller target value can be set, once the pump has been activated in step a).

According to step a) above the temperature sensor can detect the temperature of the water downstream of the heater before the first method step a) and afterwards in method step b). Alternatively a second temperature sensor can be arranged upstream of the heater and in method step b) can detect a first measurement value upstream of the heater while the temperature sensor downstream of the heater detects the second measurement value. If there is only one temperature sensor, the temperature is therefore measured before the heater is switched on and after the time period has passed in step b). With two temperature sensors it is possible to measure the temperature upstream and downstream of the heater at the same time, largely simultaneously after the passage of the defined time interval in step b).

If the evaluation of the temperature change in step c) when the pump is switched on gives the desired target value, the function of the heater has been successfully verified. The error message resulting from the function test without the pump being switched on was therefore based on a water-free heater, in other words a dry start. When the second verification step has been completed successfully, the heater is vented and ready to prepare a beverage.

However should it not be possible to detect the desired temperature change, an error message can again be generated. However with this error message it cannot be excluded that the error lies in the function of the heater or the pump.

The method described last with steps a) to d) including activation of the pump in step a) is not necessarily dependent on a function test without switching on the pump. A method for filling or venting the heater can also be performed independently thereof.

When the system has been tested for heater and pump function and the heater has been vented, in a further method the heater can be cooled in a specific manner. This method necessarily follows filling and venting and comprises the following steps:
k) disconnecting the power supply to the heater with the pump activated,
l) detecting a temperature change downstream of the heater after a defined time period has passed,
m) evaluating the detected temperature change by comparing it with a target value and
n) outputting an error message or continuing a brewing operation.

When the heater is cooled no energy is supplied. Turning off or disconnecting from the power supply according to step k) can be omitted, if it was heated by means of a defined energy block, in other words the power supply was limited in time. At the same time however the pump is activated so that as yet unheated water is conducted into the heater. In the following step l) a defined time period of for example 14 seconds is also allowed to pass, in order then to be able to detect a temperature change. It is also assigned a target value, with which it is compared in order to undertake an evaluation in respect of function or error message according to step m) from the comparison. Pump speed can be increased to shorten the time period required for this method. When the desired temperature change is established, the brewing operation can be started or continued. If however there is no temperature change or the temperature change is not sufficient, an error message is output. As in the cooling method power is not applied to the heater, the error may indicate a defect in the water-conducting system, for example a pump defect, a line blockage or an empty water tank.

According to a further advantageous embodiment of the invention, when an error message is output in step d) and/or in step n) error information can be saved in a non-volatile memory in the preparation appliance. Thus a system state from a previous method can be stored beyond its runtime and transferred to a subsequent method. The storage of error information is known as setting a flag, referring to a binary variable or a status indicator used to help with the marking of certain states. In a simple instance it only contains the information whether an error was present (0/1). In a more complex embodiment it can also contain information about the error per se. The flag can be used in particular to transfer information to the control device after a restart indicating whether it was possible to switch off the preparation device properly and without error when last used. If the heater is full for example a function test by means of a dry start can be omitted. Alternatively or additionally the flag can be used to start the preparation device automatically with filling or venting when first used by the user. The flag is deleted after filling and venting have been successfully performed.

According to a further advantageous embodiment of the invention the current water temperature is detected continuously or at short time intervals and the measurement value of the temperature is compared with a defined limit value. If the limit value is exceeded, an error message, which is not perceptible to the user, is output to the control device and the heating system is switched off. In some instances the heater can also be cooled automatically and the program can be continued when a threshold value is reached. As an alternative to continuous monitoring, monitoring can take place at short time intervals, the duration of which is shorter than the dead time of a control process of the preparation appliance. This includes for example the response time of the heater from the first heating prompt to a measurable temperature change. A dead time can comprise for example a time period of 6 seconds.

In a further advantageous embodiment of the abovementioned method the preparation appliance can be blocked completely if the limit value is exceeded by a predetermined amount. When blocked, the preparation appliance is not isolated from its power supply but put into an error mode, in which the beverage preparation operation can no longer be continued but is terminated. The user is asked to switch the preparation appliance off at least. When it is switched on again, the preparation appliance automatically starts the system test according to steps a) to d) again. If the limit value is exceeded, the amount by which the measurement value exceeds the limit value is therefore also detected. Alternatively a second limit value can be defined, which is above the first limit value. This allows a critical error to be detected, which could otherwise represent a risk to the user when the preparation appliance is restarted or the preparation operation is continued. Should the new system test also be unsuccessful, the heating device can no longer be activated by the user but only by an authorized technician. This increases the operational safety of the beverage preparation device.

The principle of the invention is described in more detail in the following by way of example with reference to a drawing, in which:

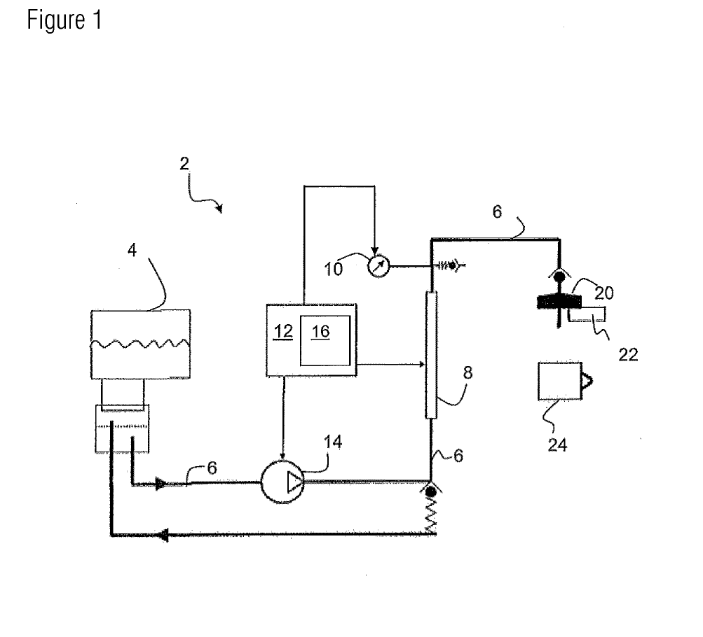

FIG. 1 shows a schematic diagram of an inventive coffee machine,

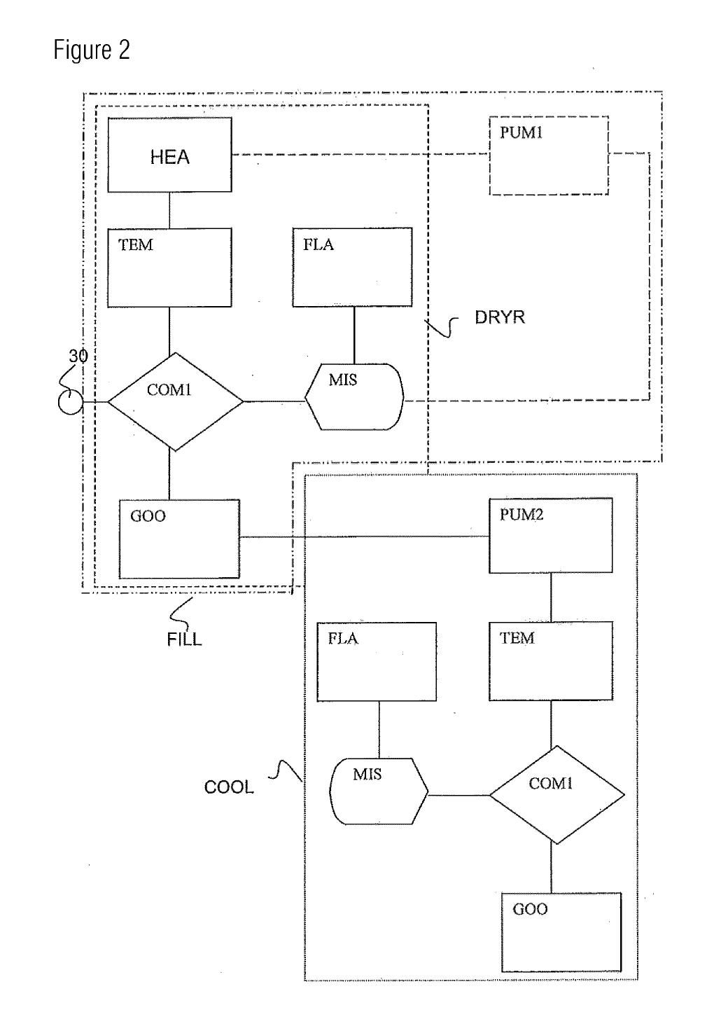

FIG. 2 shows a block circuit diagram for function tests,

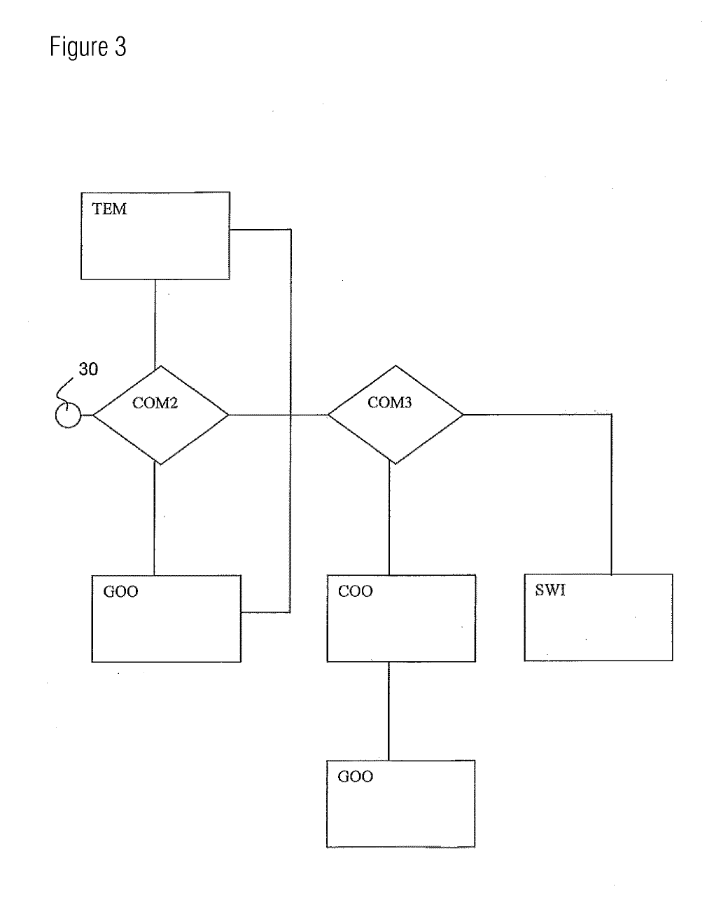

FIG. 3 shows a block circuit diagram for continuous temperature monitoring,

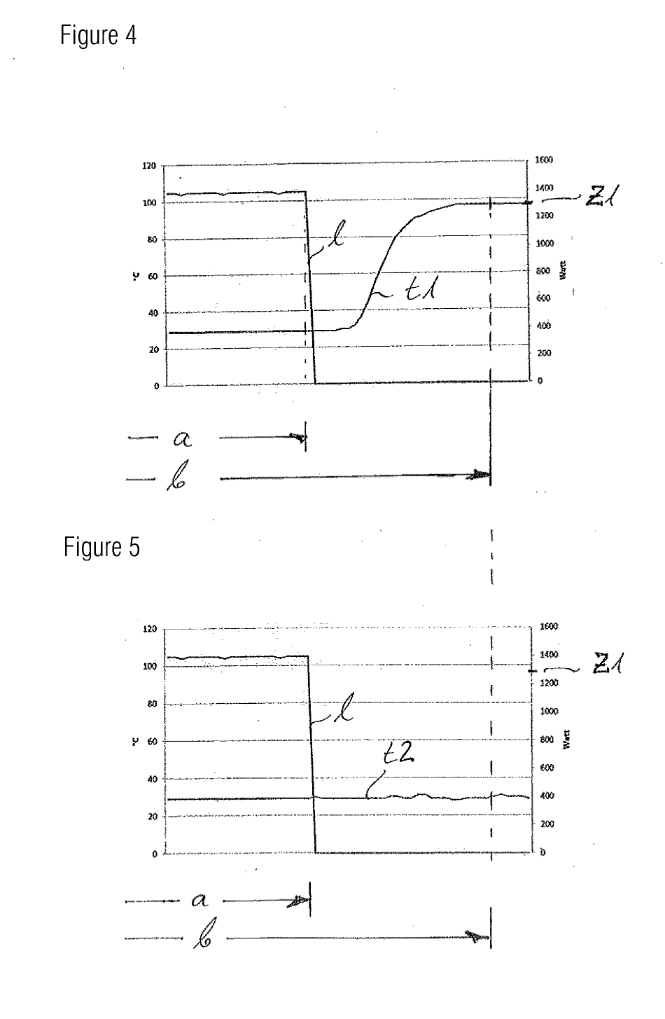

FIGS. 4 to 6 show exemplary temperature profiles for individual method steps.

FIG. 1 shows a schematic diagram of a hot beverage machine in the form of a coffee machine 2, which allows the preparation of different coffee beverages using beverage capsules 22. It has a fresh water tank 4, which is connected to a fluid inlet 6. Arranged in the water inlet 6 is an oscillating piston pump 14, which can be used to convey water from the tank 4 at an adjustable conveying rate. The water inlet 6 runs from the oscillating piston pump 14 to a heater 8, which is configured as a low-mass flow-through water heater. Arranged downstream of the heater 8 is a temperature sensor 10, which can be used to measure the temperature of the water there. The water inlet 6 extends on to a brewing chamber 20. There the heated water reaches the beverage capsule 22, through which the heated water flows, thereby absorbing aromatics, to collect in a cup 24 as the finished coffee beverage.

The coffee machine 2 has a control device 12, which is connected by way of signal lines to the pump 14, the heater 8 and the temperature sensor 10, from which it obtains measurement values and to which it can output control signals. It also comprises a non-volatile memory 16, in which values can be stored, read out and deleted. The control device 12 is therefore able to determine a throughflow or volume flow of water downstream of the flow-through water heater 8 in the manner described in DE 10 2011 079 542 B1 and DE 10 2013 201 180.

FIG. 2 shows a multi-stage sequence of a function test, during the course of which both the heater 8 and pump 14 are tested in respect of function. In a first method step DRYR, a potential so-called dry start, in a step HEA the heater 8 of the coffee machine 2 is subjected to what is known as an energy block. An exemplary energy block has a defined amount of heat energy of 1400 W during a defined time interval of 20 seconds. It is calculated from the mass of the heater 8 to be heated, the mass of water therein and a desired increase in the temperature of the water to approx. 90° C., what is known as a step response. FIG. 4 shows a temperature and heating power profile derived therefrom. For the time interval a the electric power of 1400 W is applied to the heater 8, which is then switched off. This gives the power profile I. The temperature of the water, which is already around 30° C. due to previous preparation operations according to FIG. 4, should heat up to around 90° C. with a certain time delay as a result of the heater 8 being switched on, so the temperature profile t1 results. When a low-mass flow-through water heater is used as the heater 8, the energy block can be smaller because of the lower mass of the flow-through water heater than with a thermoblock for example. The desired temperature value of the water of 90° C. corresponds to a target value z1, which is stored in the control device 12 of the coffee machine 2 or in its non-volatile memory 16.

A defined time period b defines a further time, after which a temperature is detected in step TEM (see FIG. 2). The defined time period b is longer than or equal to the time interval a. After the end of the defined time period b the temperature downstream of the heater 8 is detected. The measured value is compared with stored target value z1 in a step COM1. If the coffee machine 2 is fully functional, a temperature profile t1 according to FIG. 4 results so the measurement value from step TEM corresponds to the stored target value z1. The brewing operation can then continue in step GOO if required.

However if the comparison in step COM1 does not result in the measurement value corresponding to the stored target value, there is an error, which is signaled in step MIS. FIG. 5 shows the associated temperature profile t2 for the same power profile I; after the end of the energy block the temperature profile t2 shows no change, so the target value is not reached. A flag is then set in the non-volatile memory 16 of the control device 12 in step FLA. It indicates that the first test step has resulted in an error which has not yet been identified further. Should the coffee machine 2 then be switched off, the error information is retained so that when the coffee machine 2 has been switched on again the control device 12 can access the stored information and initiate a corresponding method.

The error detected in step MIS can have different causes. It can for example be due to the temperature sensor 10 failing or the heater 8 not functioning. In a simple and the most common instance however it can be due to the heater 8 not being filled with water so that it was not able to output the energy of the energy block to the water and then produce a step response at the temperature sensor 10. In order to exclude this possibility, after the error has occurred in step MIS a further method segment FILL (see FIG. 2) for filling or venting the heater 8 can be performed. To this end in a step PUM1 the pump 14 is activated, while the energy block is applied to the heater 8. This ensures filling or venting of the heater 8 if the pump 14 operates in the required manner. The method steps TEM, COM1, GOO or MIS and FLA are then run through largely without change, with the proviso that the stored target value of the step response must be smaller because there is now a flow through the heater 8 and therefore a step response to the same degree as when the water in the heater 8 is still cannot be expected.

If the result of step COM1 is the desired step response, a temperature profile t1 is present and the brewing operation can be continued in step GOO and the set flag from step FLA can be deleted. Otherwise an error is output in step MIS and a new flag is set in step FLA. The preparation appliance can then be blocked or error elimination or error limitation can be undertaken, for example by asking the user to check the water tank and fill it if necessary or the pump can be switched on to convey water into the heater. After error elimination or error limitation the method segment FILL is repeated to fill or vent the heater 8.

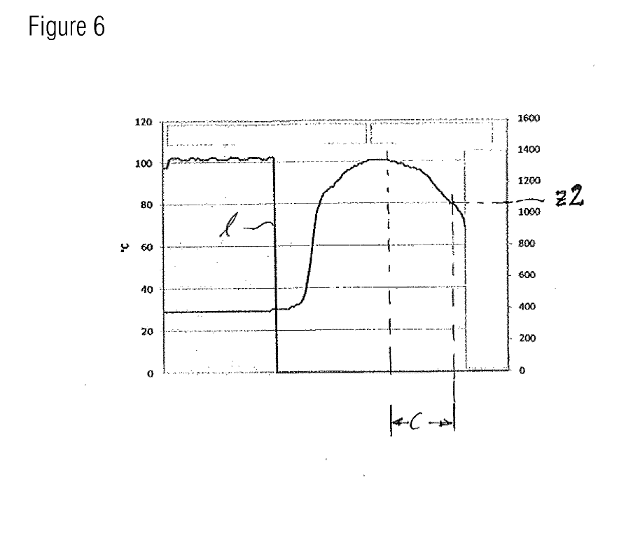

If there is no error message, successful venting or filling of the heater can be followed by a further method segment COOL (see FIG. 2) for function testing, namely specific cooling of the heater 8. To this end the heater 8 is disconnected from the power supply or left without power at the end of the energy block, while the pump 14 is or remains activated (see step PUM2). This method also follows the same principle as the previous one, namely that after the end of a defined time period in a subsequent step TEM a temperature downstream of the heater 8 is detected. FIG. 6 shows a temperature profile t3 of a complete function test, resulting when the pump 14 and heater function correctly. After the time period b, in other words when the pump 14 is functioning correctly and the heater 8 has been switched off in the meantime, the temperature drops. The time period now considered for the activity of the pump 14 is shown as c and is approx. 10 seconds. A temperature different of at least 20° C. should be reached during this time period. The measurement value z2 detected after passage of the time period c is compared in step COM1 with a target value calculated from the planned temperature difference. If it is reached, a temperature profile t3 according to FIG. 6 can be assumed, the flag can be deleted if necessary and the brewing operation can be continued in step GOO.

However if the target value z2 is not reached, in step MIS an error message is again prompted, accompanied by the setting of a flag according to step FLA, storing corresponding information in the memory 16 of the control device 12. Then—as in the procedure above—the preparation appliance can be blocked or error elimination or error limitation can be undertaken, for example by means of more pumping, to achieve cooling. Error elimination or error limitation is followed again by the method step COOL for cooling the heater 8.

FIG. 4 shows a further test method, which is performed both during the function tests according to FIG. 3 and during a subsequent conventional brewing operation. According to this a temperature is detected at short intervals according to step TEM. In a subsequent step COM2 the detected value is compared with stored target values detected in the factory for the respective methods or operating states of the coffee machine 2 and stored in its memory 16. If the limit value is complied with, in step GOO the brewing operation continues without change and there is a return to step TEM. However if the limit value is exceeded in step COM2, in a subsequent step COM3 the amount by which the limit value has been exceeded is verified. This distinguishes between non-critical errors and critical errors. For example should the amount by which the limit value is exceeded lie within a defined interval, in a step COO the heater 8 is switched off and cooled by way of the control device 12 until it is below the critical limit value and brewing then continues without change in step GOO. The quantity of water required for the system test is detected and buffered so that it can be deducted during the subsequent preparation of the beverage. This means that the correct quantity of beverage reaches the cup.

However if the interval is exceeded in step COM3, in the subsequent step SW1 a critical error is detected, with which the heater 8 is also switched off but without it then being possible for the user to reactivate it. The coffee machine 2 is also switched off and a flag is set indicating the critical error. The coffee machine 2 can now only be actuated by a technician in order to be repaired.

The method according to FIG. 3 runs continuously or at short intervals between the steps GOO and TEM. The intervals are shorter than a dead time of the control process between the heater 8 and the temperature sensor 10 and last for example 6 seconds. If the method runs at the same time as one of the methods according to FIG. 2, it can overlap with the method step TEM there in so far as it takes over the measurement value determined therein. It then follows on with step COM2 at the coupling point 30.

### LIST OF REFERENCE CHARACTERS

HEA Load energy block into heater
TEM Temperature detection
COM1 Comparison with target value
COM2 Comparison with a limit value
COM3 Comparison of the excess with a target value
GOO Continuation of brewing operation
MIS Error message
FLA Setting of a flag
PUM Pump activation
COO Cooling operation
SWI Switch off system
DRYR Test method dry start
FILL Test method fill/vent system
COOL Test method cool
2 Coffee machine
4 Water tank
6 Water inlet
8 Heater
10 Temperature sensor
12 Control device
14 Pump
16 Memory
20 Brewing chamber
22 Beverage capsule
24 Cup
30 Coupling point

1-9. (canceled)

10. A method for controlling a hot beverage preparation appliance, the appliance having a heater, at least one temperature sensor downstream of the heater in a water conveying direction, a pump for conveying water within the preparation appliance, and a control device for controlling the heater and the pump, the method comprising the following steps:
a) applying electric power to the heater;
b) detecting a temperature change downstream of the heater after a defined time period has elapsed;
c) evaluating the temperature change detected in step b) by comparing the temperature change with a target value;
d) outputting an error message or continuing/initiating a brewing operation.

11. The method according to claim 10, which comprises performing the method steps in a hot beverage machine for household use.

12. The method according to claim 10, wherein the electric power in step a) corresponds to a predetermined amount of energy, which corresponds to the defined target value according to step c) for the temperature change.

13. The method according to claim 10, which comprises activating the pump in step a) to fill or vent the heater.

14. The method according to claim 13, which comprises initiating a process of filling/venting the heater after an error message is output in step d).

15. The method according to claim 13, which comprises, after a process of filling/venting the heater performing a process for cooling the heater with the following steps:
k) disconnecting a power supply to the heater;
l) detecting a temperature change downstream of the heater after a defined time period has elapsed;
m) evaluating the detected temperature change by comparing the temperature change with a target value; and
n) outputting an error message or continuing/initiating the brewing operation.

16. The method according to claim 15, which comprises changing a power of the pump while the heater operates without power in step k).

17. The method according to claim 15, which comprises, with regard to the error message in one or both of step d) or step n), storing information relating to the error message in a non-volatile memory of the preparation device, to be accessed at a start of a further process.

18. The method according to claim 10, which comprises, with regard to the error message in step d), storing information relating to the error message in a non-volatile memory of the preparation device, to be accessed at a start of a further process.

19. The method according to claim 10, which comprises detecting a current water temperature continuously or at intervals and comparing a value of the temperature with a defined limit value and, if the limit value is exceeded, outputting a fault message and switching off the heater.

20. The method according to claim 19, which comprises, if the limit value is exceeded by a predetermined amount, switching the heater off irreversibly for a user and also switching off the preparation device.
